(19) United States
(12) Patent Application Publication
(10) Pub. No.: US 2020/0063078 A1
(43) Pub. Date: Feb. 27, 2020

(54) MARIJUANA INFUSED CRAFT BEER RECIPE AND PROCESS

(71) Applicant: John McCreedy, Maple Ridge ON (CA)

(72) Inventor: John McCreedy, Maple Ridge ON (CA)

(21) Appl. No.: 16/112,300

(22) Filed: Aug. 24, 2018

(51) Int. Cl. C12C 5/02; C12C 7/04; C12C 7/14; C12C 7/20; C12C 7/26; C12C 11/09

(52) U.S. Cl. CPC C12C 5/026; C12C 7/042; C12C 11/09; C12C 7/205; C12C 7/26; C12C 7/14

(57) ABSTRACT

A method of processing a marijuana infused craft known as “Dry Budding”, the method including the steps of: mashing with water and milled-grains to form a mash; lautering wherein the mash is separated into clear liquid wort and residual-grain; boiling, adding hops and heating to form a hopped-wort; cooling the hopped-wort and adding oxygen; fermenting via yeast and allowing CO₂ to be released; filtering a fermented-solution; and packaging a filtered-fermented-solution. The marijuana is incorporated into the craft beer using only marijuana flowers and marijuana leaves to induce infusion creating a psycho-active effect ingestible beverage as the marijuana infused craft beer. In alternate processes the marijuana is incorporated into the craft beer in different steps.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of beverage solutions and beverage processes of existing art and more specifically relates to a marijuana infused craft beer recipe and process.

### Related Art

Many individuals in modern society consume marijuana for medical or recreational use. Cannabis, also known as marijuana is a psychoactive drug from the Cannabis plant. The main psychoactive part of cannabis is tetrahydrocannabinol (THC), one of 483 known compounds in the plant, including at least 65 other cannabinoids. Cannabis can be used by smoking, vaporizing, within food, or as an extract. Cannabis is often used for its mental and physical effects, such as a “high” or “stoned” feeling, a general change in perception, euphoria, and an increase in appetite. Many individuals use marijuana in modern society for medical purposes. Unique means for intaking marijuana is desirable.

U.S. Pub. No. 2012/0124704 to Lucas Szymanowski relates to infusion of cannabis. The described infusion of cannabis includes a method for infusing Cannabis. The method includes preparing the Cannabis. The method also includes placing the Cannabis in an infusible liquid. The infusible liquid is suitable for human consumption and configured to remove one or more chemical compounds from the infusible liquid.

### SUMMARY OF THE INVENTION

In view of the foregoing disadvantages inherent in the known drug, bio-affecting and body treating compositions art, the present disclosure provides a novel marijuana infused craft beer recipe and process. The general purpose of the present disclosure, which will be described subsequently in greater detail, is to provide a recipe to incorporate marijuana into craft beer using only the flowers and leaves naturally as a new alternative to consume marijuana called Dry Budding.

A method of dry budding where in processing a marijuana infused craft beer is disclosed herein, the method comprising the steps of: mashing with water and milled-grains to form a mash; lautering wherein the mash is separated into clear liquid wort and residual-grain; boiling, adding hops and heating to form a hopped-wort; cooling the hopped-wort and adding oxygen; fermenting via yeast and allowing CO₂ to be released; filtering a fermented-solution; and packaging a filtered-fermented-solution. The decarboxylated marijuana is incorporated into the craft beer at least in step adding hops and heating stage using only marijuana flowers and marijuana leaves to induce infusion creating a psycho-active effect ingestible beverage as the marijuana infused craft beer. In alternate processes the marijuana is incorporated into the craft beer in additional steps.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a marijuana infused craft beer recipe and process, constructed and operative according to the teachings of the present disclosure.

FIG. 1 is a perspective view of the marijuana infused craft beer recipe as being consumed during an ‘in-use’ condition, according to an embodiment of the disclosure.

FIG. 2 is a flow diagram illustrating a recipe for the marijuana infused craft beer, according to an embodiment of the present disclosure.

FIG. 3 is a flow diagram illustrating a method of process for the marijuana infused craft beer recipe and process, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a beverage solutions and beverage processes and more particularly to a marijuana infused craft beer recipe and process as used to improve the processing of and intake of marijuana.

Generally, the present invention provides unique craft beer recipes infusing decarboxylated marijuana and/or marijuana concentrates into the beer recipes without the use of oils and alcohol tinctures. The process is call dry budding and includes precise measurements of decarboxylated marijuana and marijuana concentrates during specific times during the beer making process. The marijuana is absorbed into the beer during production resulting in the beer becoming psycho-active. The consumer can taste and will feel the effect of the marijuana in the beer much like that of other edible marijuana products. Disclosed is a dry bud recipe serving to incorporate marijuana into craft beer using only the flowers and leaves naturally. This is a new alternative to consume marijuana.

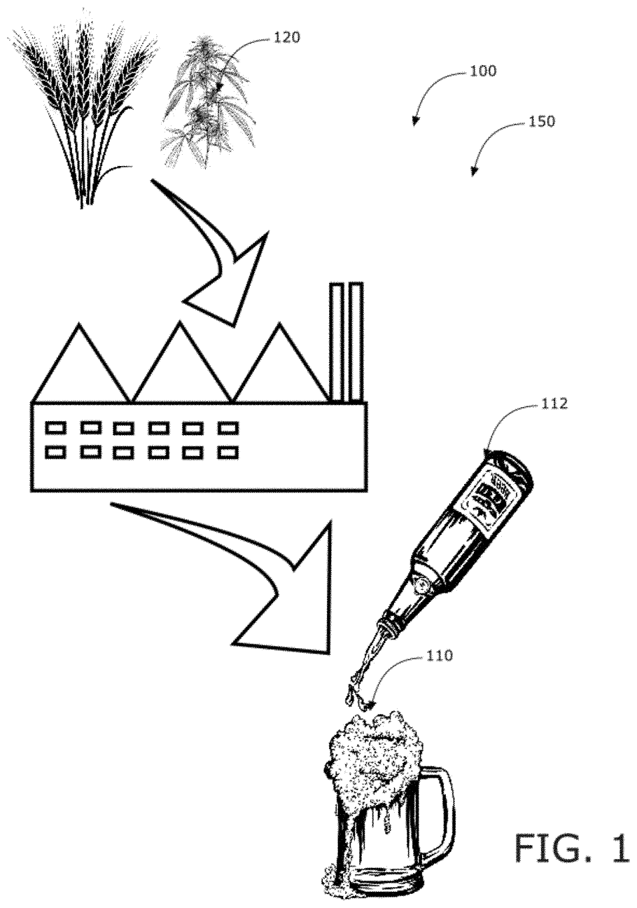

Referring now more specifically to the drawings by numerals of reference, there is shown in FIGS. 1-3, various views of a marijuana infused craft beer recipe and process 100.

FIG. 1 shows a marijuana infused craft beer recipe and dry bud process 100 during an ‘in-use’ condition 150, according to an embodiment of the present disclosure. Here, the marijuana infused craft beer recipe and process 100 may be beneficial for use by a user consumer to provide a tasty consumable beverage 110 that may induce positive effects in the consumer of the beverage 110.

According to one embodiment, the marijuana infused craft beer recipe and dry budding process 100 may be arranged as a kit. In particular, the marijuana infused craft beer recipe and process 100 may further include a set of instructions. The instructions may detail functional relationships in relation to the structure of the marijuana infused craft beer recipe and process 100 such that the marijuana infused craft beer recipe and process 100 can be used, maintained, or the like, in a preferred manner for home use or commercial use.

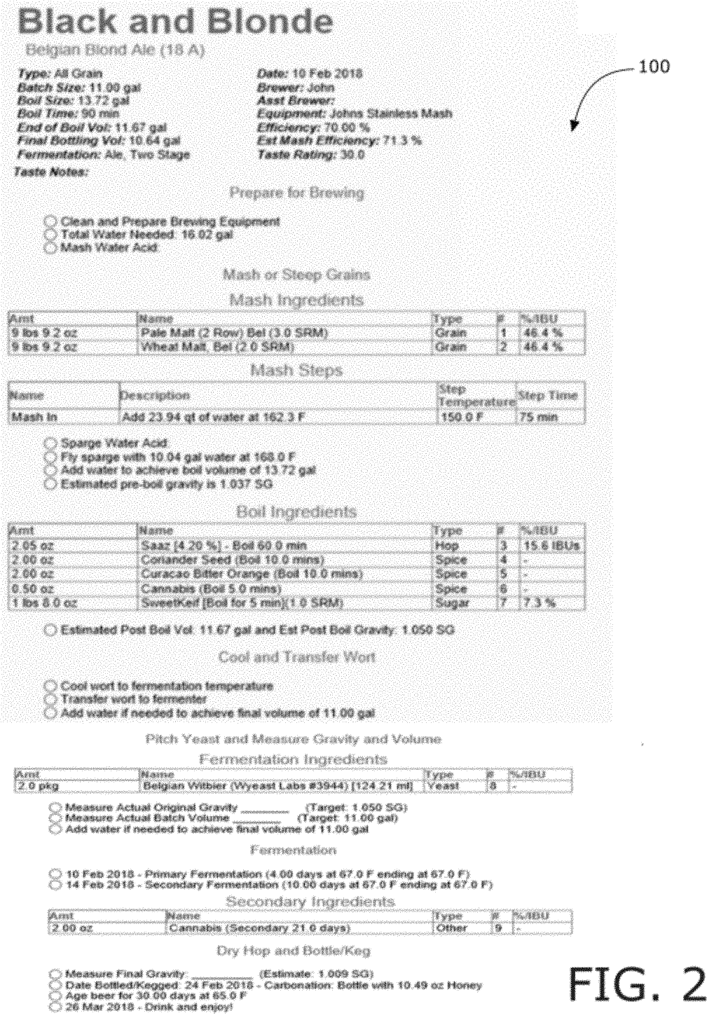

Referring now to FIG. 2 showing a flow diagram illustrating a dry bud recipe for the marijuana infused craft beer 112, according to an embodiment of the present disclosure.

The following is a recipe for use with the present invention:

A method of processing a marijuana infused craft beer 112 comprises the steps of: mashing with water and milled-grains to form a mash; lautering wherein the mash is separated into clear liquid wort and residual-grain; boiling, adding hops and heating to form a hopped-wort; cooling the hopped-wort and adding oxygen; fermenting via yeast and allowing CO₂ to be released; filtering a fermented-solution; and packaging a filtered-fermented-solution. The marijuana is incorporated into the craft beer at least in the step of adding hops and heating phase using only flowers and leaves (as hops to provide infused flavor and may impart bitter, zesty, or citric/earthy plant flavors as per recipe used) to induce infusion creating a psycho-active effect ingestible beverage as the dry bud marijuana infused craft beer 112. In alternate processes the marijuana 120 is incorporated into the craft beer in additional steps. Further, the marijuana 120, when infused as hops (or in combination with other hops), may have an antibacterial effect over less desirable microorganisms useful for balancing the sweetness of the malt with bitterness and a variety of flavors and aromas. Fermenting may comprise a primary-fermentation and a secondary-fermentation. The fermenting step converts the hopped-wort into ethanol and the CO₂. The marijuana 120 used in the present invention is decarboxylated. No oil is used and no alcohol tinctures are used. The “SweetKeif” is the crystals found on the plant buds shown above. The plant buds and Keif are added at the boiling phase, then more buds referred to as “Dry Budding” are added at the fermentation phase, and more Keif at the packaging/bottling phase.

The marijuana infused craft beer system may incorporate marijuana being incorporated into the craft beer at steps mashing; lautering; cooling; fermenting.

Referring now to the milled-grains able to be used; the milled-grains may comprise barley; wheat; corn; rice; rye; and oats. Upon reading this specification, it should be appreciated that, under appropriate circumstances, considering such issues as user preferences, design preference, structural requirements, marketing preferences, cost, available materials, technological advances, etc., other milled grains, and non-grains as are suitable for fermentation and flavor may be used.

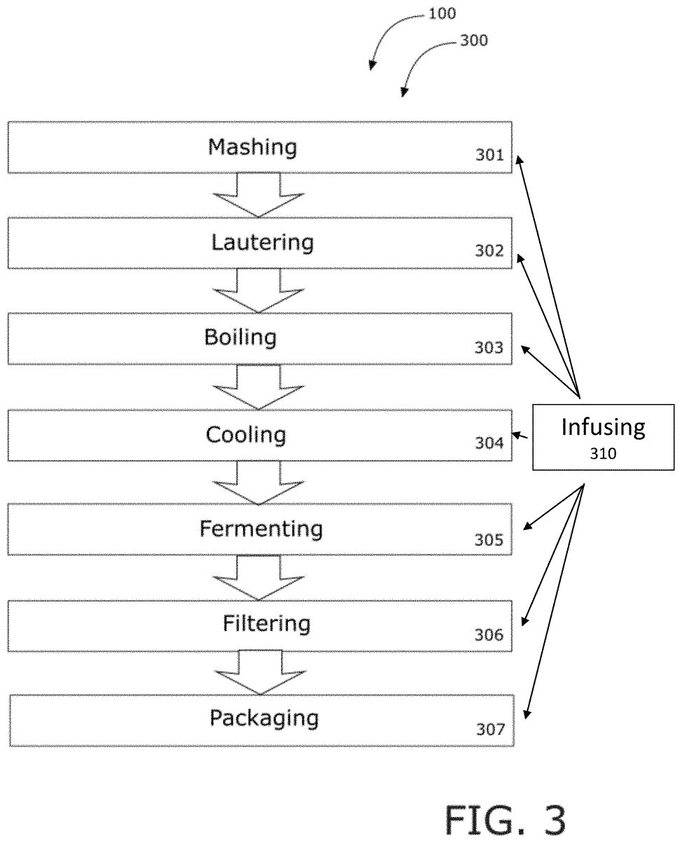

Referring now to FIG. 3 showing a flow diagram illustrating a method of process 300 for the marijuana infused craft beer recipe and dry budding process, according to an embodiment of the present disclosure. In particular, the method of use 300 may include one or more components or features of the marijuana infused craft beer recipe and process 100 as described above. As illustrated, the method of use 300 may include the steps of: step one 301, mashing with water and milled-grains to form a mash; step two 302, lautering wherein the mash is separated into clear liquid wort and residual-grain; step three 303, boiling, adding hops and heating to form a hopped-wort; step four 304, cooling the hopped-wort and adding oxygen; step five 305 fermenting via yeast and allowing CO₂ to be released; step six 306 filtering a fermented-solution; and step seven 307 packaging a filtered-fermented-solution; wherein marijuana (marijuana is decarboxylated) is incorporated 310 into the craft beer at least in the step of adding hops and heating using only flowers and leaves to induce infusion creating a psycho-active effect ingestible beverage as the marijuana infused craft beer. As previously mentioned no oil is used as well as no alcohol tinctures are used. The milled-grains may comprise barley, and alternately wheat, and alternately corn, and alternately rice, and alternately rye, and alternately oats or other suitable alternative or combination thereof. Using the present recipe and process marijuana may be incorporated 310 into the craft beer at step mashing; and/or lautering; and/or cooling; and/or fermenting or other phases. Those with ordinary skill in the art will now appreciate that upon reading this specification and by their understanding the art of beer making and infusing as described herein, methods of dry budding infusing during beer making and phases of will be understood by those knowledgeable in such.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for mashing, lautering, boiling, adding hops and heating, cooling, fermenting, filtering, and infusing marijuana in at various stages are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method of processing a marijuana infused craft beer, the method comprising the steps of:
mashing with water and milled-grains to form a mash;
lautering wherein said mash is separated into clear liquid wort and residual-grain;
boiling, adding hops and heating to form a hopped-wort;
cooling said hopped-wort and adding oxygen;
fermenting via yeast and allowing CO₂ to be released;
filtering a fermented-solution; and
packaging a filtered-fermented-solution; and
wherein marijuana is incorporated into craft beer at least in step of adding hops and heating using only flowers and leaves to induce infusion creating a psycho-active effect ingestible beverage as said marijuana infused craft beer.

2. The method of processing of claim 1, wherein said fermenting comprises a primary-fermentation and a secondary-fermentation.

3. The method of processing of claim 1, wherein said marijuana is decarboxylated.

4. The method of processing of claim 1, wherein no oil is used.

5. The method of processing of claim 1, wherein no alcohol tinctures are used.

6. The method of processing of claim 1, wherein the fermenting converts said hopped-wort into ethanol and said CO₂.

7. The marijuana infused craft beer system of claim 1, wherein the marijuana is incorporated into said craft beer at step mashing.

8. The marijuana infused craft beer system of claim 7, wherein the marijuana is incorporated into said craft beer at step lautering.

9. The marijuana infused craft beer system of claim 8, wherein the marijuana is incorporated into said craft beer at step fermenting.

10. The marijuana infused craft beer system of claim 9, wherein the milled-grains comprise barley.

11. The marijuana infused craft beer system of claim 9, wherein the milled-grains comprise milled-grains comprise wheat.

12. The marijuana infused craft beer system of claim 9, wherein the milled-grains comprise corn.

13. The marijuana infused craft beer system of claim 9, wherein the milled-grains comprise rice.

14. The marijuana infused craft beer system of claim 9, wherein the milled-grains comprise rye.

15. The marijuana infused craft beer system of claim 9, wherein the milled-grains comprise oats.

16. The marijuana infused craft beer system of claim 9, wherein the hops impart bitter, zesty, and alternately citric flavors.

17. A method of processing a marijuana infused craft beer, the method comprising the steps of:
mashing with water and milled-grains to form a mash;
lautering wherein said mash is separated into clear liquid wort and residual-grain;
boiling, adding hops and heating to form a hopped-wort;
cooling said hopped-wort and adding oxygen;
fermenting via yeast and allowing CO₂ to be released;
filtering a fermented-solution; and
packaging a filtered-fermented-solution; and
wherein marijuana is incorporated into craft beer at least in the step of adding hops and heating using only flowers and leaves to induce infusion creating a psycho-active effect ingestible beverage as said marijuana infused craft beer;
wherein said marijuana is decarboxylated;
wherein no oil is used;
wherein no alcohol tinctures are used; and
wherein the milled-grains comprise barley, and alternately wheat, and alternately corn, and alternately rice, and alternately rye, and alternately oats.

18. The method of claim 17, wherein the marijuana is incorporated into said craft beer at step mashing.

19. The method of claim 18, wherein the marijuana is incorporated into said craft beer at step lautering.

20. The method of claim 19, wherein the marijuana is incorporated into said craft beer at step fermenting.
